(19) United States
(12) Patent Application Publication
(10) Pub. No.: US 2026/0106822 A1
(43) Pub. Date: Apr. 16, 2026

(54) COMMUNICATION SYSTEM

(71) Applicant: DENSO CORPORATION, Kariya-city (JP)

(72) Inventors: Mana TANAKA, Kariya-city (JP); Tomoya TOKUNAGA, Kariya-city (JP); Akira TADA, Kariya-city (JP); Yukihiro YAMAKAWA, Kariya-city (JP); Tomohisa KISHIGAMI, Kariya-city (JP)

(21) Appl. No.: 19/353,734

(22) Filed: Oct. 9, 2025

(30) Foreign Application Priority Data
Oct. 15, 2024 (JP) 2024-179848

(51) Int. Cl. H04L 45/24; H04L 45/00; H04L 45/02

(52) U.S. Cl. CPC H04L 45/24; H04L 45/02; H04L 45/22

(57) ABSTRACT

A communication system includes a first electronic control device and a plurality of second electronic control devices. The first electronic control device and the plurality of second electronic control devices are each communicably connected via a main path. At least one of the plurality of second electronic control devices is communicably connected to another of the second electronic control devices via a redundant path. The first electronic control device is configured to transmit data to the second electronic control device via the main path connected to the second electronic control device. The first electronic control device is configured to transmit the data to the second electronic control device by reducing the data communication amount via a backup path.

### CROSS REFERENCE TO RELATED APPLICATION

This application is based on Japanese Patent Application No. 2024-179848 filed on Oct. 15, 2024, the disclosure of which is incorporated herein by reference.

### TECHNICAL FIELD

The present disclosure relates to a technology applicable to systems in which communication is made redundant.

### BACKGROUND

In recent years, communication control methods for ring networks composed of a plurality of communication devices have been disclosed. A ring network is a network configured by connecting a plurality of nodes in a ring shape.

Furthermore, as a fail-safe measure in the event of communication failure, methods for making communication redundant are known, and as one such method of redundancy, the aforementioned ring network has been proposed.

### SUMMARY

According to an aspect of the present disclosure, a communication system includes a first electronic control device and a plurality of second electronic control devices. The first electronic control device and the plurality of second electronic control devices may be each communicably connected via a main path. At least one of the plurality of second electronic control devices may be communicably connected to another of the second electronic control devices via a redundant path having a lower transmission capacity with respect to data communication amount than the main path. The first electronic control device may be configured to transmit data to the second electronic control device, which is a transmission target of the data, via the main path connected to the second electronic control device, which is a transmission target of the data. The first electronic control device may be configured to transmit the data to the second electronic control device, which is a transmission target of the data, by reducing the data communication amount via a backup path including another main path different from the main path and the redundant path.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing the configuration of the communication system according to the first embodiment;

FIG. 2A is an explanatory diagram functionally showing the configuration of a mobility computer;

FIG. 2B is an explanatory diagram functionally showing the configuration of the zone ECU;

FIG. 2C is an explanatory diagram functionally showing the configuration of the terminal ECU;

FIG. 3 is an explanatory diagram showing the position of communication disconnection in the communication system;

FIG. 4 is a flowchart showing the first control process;

FIG. 5 is an explanatory diagram showing the position of communication disconnection and the backup path in the communication system;

FIG. 6 is a flowchart showing the second control process;

FIG. 7 is an explanatory diagram showing the position of communication disconnection and the backup path in the communication system;

FIG. 8 is a flowchart showing the third control process;

FIG. 9 is an explanatory diagram showing the position of communication disconnection and the backup path in the communication system;

FIG. 10 is a flowchart showing the fourth control process;

FIG. 11 is a block diagram showing the configuration of the communication system according to the second embodiment;

FIG. 12 is a block diagram showing the configuration of the communication system according to the third embodiment;

FIG. 13 is a flowchart showing the frame transmission process of the third embodiment;

FIG. 14 is a flowchart showing the frame forwarding process of the third embodiment;

FIG. 15 is a flowchart showing the failure detection process of the third embodiment;

FIG. 16 is a flowchart showing the master activation process of the fourth embodiment;

FIG. 17 is a flowchart showing the slave activation process of the fourth embodiment; and

FIG. 18 is a flowchart showing the restart process of the fourth embodiment.

### DETAILED DESCRIPTION

As a result of detailed studies by the inventors, the following issues have been identified with the conventional technology. For example, when constructing a ring network using a main communication line and a communication line for redundancy (i.e., a redundant communication line), the data communication amount (also referred to as the amount of data that can be transmitted per unit time, or communication bandwidth) of the redundant communication line may be less than the data communication amount of the main communication line.

However, in cases where the data communication amount of the redundant communication line is less than that of the main communication line, sufficient consideration has not been given to how and under what circumstances data should be transmitted. For example, when a communication failure occurs on the main communication line, sufficient consideration has not been given to how data should be transmitted using the redundant communication line.

The present disclosure provides a technology capable of appropriately transmitting data to a transmission target in a ring network.

According to one aspect of the present disclosure, a communication system comprises a first electronic control device; and a plurality of second electronic control devices. The first electronic control device and the plurality of second electronic control devices are each communicably connected via a main path. At least one of the plurality of second electronic control devices is communicably connected to another of the second electronic control devices via a redundant path having a lower transmission capacity with respect to data communication amount than the main path. The first electronic control device is configured to transmit data to the second electronic control device, which is a transmission target of the data, via the main path connected to the second electronic control device, which is a transmission target of the data. The first electronic control device is configured to transmit the data to the second electronic control device, which is a transmission target of the data, by reducing the data communication amount via a backup path including another main path different from the main path and the redundant path.

With such a configuration, in the present disclosure, it is possible to transmit data to the transmission target via the main path, and also to transmit data to the same transmission target via the redundant path. Further, when transmitting data via the redundant path, it is possible to transmit the data with a reduced data communication amount. Furthermore, since data can be transmitted to the transmission target via both the main path and the redundant path, even if communication via the main path is disconnected, data can be transmitted via the redundant path. Incidentally, “path” in the present disclosure may also be referred to as “route”.

Hereinafter, exemplary embodiments of the present disclosure will be described with reference to the drawings.

### 1. First Embodiment

### 1-1. Overall Configuration

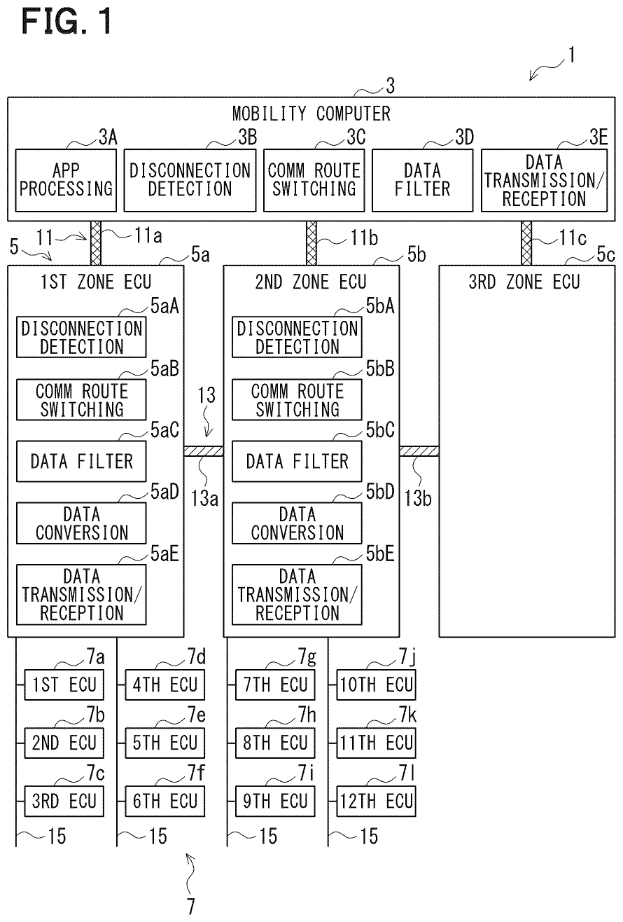

As shown in FIG. 1, the communication system 1 of the first embodiment is a communication system 1 mounted, for example, on a vehicle such as an automobile.

The communication system 1 of the first embodiment is based on a zone architecture and uses a plurality of electronic control devices arranged according to divisions called zones (i.e., installation locations in the vehicle).

The communication system 1 comprises a mobility computer (i.e., management control device) 3, a plurality of zone ECUs 5 (for example, a first zone ECU 5a, a second zone ECU 5b, and a third zone ECU 5c) communicably connected to the mobility computer 3, and a plurality of terminal ECUs 7 communicably connected to each zone ECU 5. As will be described later, this communication system 1 has a so-called ring network configuration. The terminal ECU 7 may also be simply referred to as ECU 7. ECU stands for Electronic Control Unit.

The mobility computer 3 is a control device capable of controlling each zone ECU 5 connected thereto, and the mobility computer 3 and each zone ECU 5 are communicably connected via a main path, namely, a main communication line 11. The main communication line 11 is, for example, a communication line capable of communication by Ethernet (registered trademark) or the like. Hereinafter, the communication line may be a communication bus. Note that communication by CAN (for example, CAN FD) may also be possible. CAN stands for Controller Area Network. CAN FD stands for CAN With Flexible Data Rate.

Examples of the main communication line 11 include a first main communication line 11a connected to the first zone ECU 5a, a second main communication line 11b connected to the second zone ECU 5b, and a third main communication line 11c connected to the third zone ECU 5c.

Each zone ECU 5 is a control device capable of controlling each terminal ECU 7 connected thereto. The first zone ECU 5a and the second zone ECU 5b are communicably connected by a first redundant communication line 13a, which is a redundant communication line 13. The second zone ECU 5b and the third zone ECU 5c are communicably connected by a similar second redundant communication line 13b. The redundant communication line 13 is, for example, a communication line capable of communication by Ethernet or CAN or the like. The redundant communication line 13 is a redundant path having a lower transmission capability (i.e., lower data transmission capacity, or a smaller data communication amount per unit time) than the main communication line 11.

Hereinafter, the case where the first zone ECU 5a and the second zone ECU 5b are used will be described as an example. Each zone ECU 5 and each terminal ECU 7 are connected by a terminal communication line 15 capable of communication by CAN. Each zone ECU 5 is connected to a plurality (for example, two) of terminal communication lines 15, and a plurality of terminal ECUs 7 are connected to each terminal communication line 15.

For example, the first zone ECU 5a is connected to a first terminal ECU 7a, a second terminal ECU 7b, a third terminal ECU 7c, a fourth terminal ECU 7d, a fifth terminal ECU 7e, a sixth terminal ECU 7f, and so on. The second zone ECU 5b is connected to a seventh terminal ECU 7g, an eighth terminal ECU 7h, a ninth terminal ECU 7i, a tenth terminal ECU 7j, an eleventh terminal ECU 7k, a twelfth terminal ECU 7l, and so on.

Here, the communicable data amount (i.e., communication speed) has the relationship:
“Communication speed a of the main communication line 11>2×(communication speed c of each terminal communication line 15)>communication speed c of the redundant communication line 13.”

### 1-2. Configuration of Each Control Device

Next, the hardware configuration of each control device will be briefly described.

### Mobility Computer

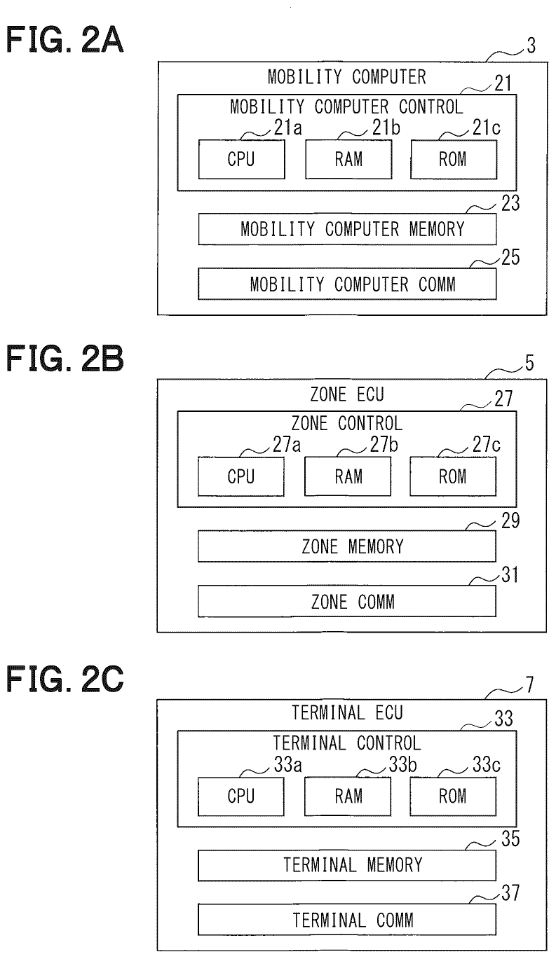

As shown in FIG. 2A, the mobility computer 3 is an electronic control device that controls the overall operation of the communication system 1, and includes a mobility computer control unit 21, a mobility computer storage unit 23, and a mobility computer communication unit 25. A storage unit may be referred to as a memory unit.

The mobility computer control unit 21 is a device that performs various calculations and processing related to the operation of the mobility computer 3, and is mainly configured around a microcomputer (also referred to as a microcontroller) having, for example, a CPU 21a, RAM 21b, ROM 21c, and the like.

The various functions of the mobility computer control unit 21 are realized by the CPU 21a executing a program stored in a non-transitory tangible recording medium. In this example, for instance, the ROM 21c corresponds to the non-transitory tangible recording medium storing the program. When this program is executed, the method corresponding to the program is executed.

The number of microcontrollers constituting the mobility computer control unit 21 may be one or more. The means for realizing the various functions of the mobility computer control unit 21 are not limited to software, and some or all elements may be realized using one or more hardware components. For example, when the above functions are realized by electronic circuits as hardware, the electronic circuit may be a digital circuit including a large number of logic circuits, an analog circuit, or a combination thereof.

Examples of the mobility computer storage unit 23 include a non-volatile memory. For example, rewritable flash memory or EEPROM and the like may be used. The mobility computer communication unit 25 is a communication device capable of transmitting and receiving data and other communications with each zone ECU 5 via each main communication line 11.

### Zone ECU

As shown in FIG. 2B, the zone ECU 5 is an electronic control device that controls the operation of the zone ECU 5, and includes a zone control unit 27, a zone storage unit 29, and a zone communication unit 31.

The zone control unit 27 is a device that performs various calculations and processing related to the operation of the zone ECU 5, and is mainly configured around a microcontroller having, for example, a CPU 27a, RAM 27b, ROM 27c, and the like.

The various functions of the zone control unit 27 are realized by the CPU 27a executing a program stored in a non-transitory tangible recording medium. The zone control unit 27 is fundamentally similar to the mobility computer control unit 21 described above, so its explanation is omitted.

Examples of the zone storage unit 29 include a non-volatile memory. For example, rewritable flash memory or EEPROM and the like may be used. The zone communication unit 31 is a communication device capable of transmitting and receiving data and other communications with the mobility computer 3 via each main communication line 11. It is also a communication device capable of transmitting and receiving data and other communications with each terminal ECU 7 via the terminal communication line 15.

### Terminal ECU

As shown in FIG. 2C, the terminal ECU 7 is an electronic control device that controls the operation of the terminal ECU 7, and includes a terminal control unit 33, a terminal storage unit 35, and a terminal communication unit 37.

The terminal control unit 33 is a device that performs various calculations and processing related to the operation of the terminal ECU 7, and is mainly configured around a microcontroller having, for example, a CPU 33a, RAM 33b, ROM 33c, and the like.

The various functions of the terminal control unit 33 are realized by the CPU 33a executing a program stored in a non-transitory tangible recording medium. The terminal control unit 33 is fundamentally similar to the mobility computer control unit 21 described above, so its explanation is omitted.

Examples of the terminal storage unit 35 include a non-volatile memory.

For example, rewritable flash memory or EEPROM and the like may be used. The terminal communication unit 37 is a communication device capable of transmitting and receiving data and other communications with each zone ECU 5 via each terminal communication line 15.

### 1-3. Functional Configuration

Next, the communication system 1 will be described functionally. Returning to FIG. 1, the mobility computer 3 functionally includes an application processing unit 3A (corresponding to APP processing unit), a disconnection detection unit 3B, a communication path switching unit 3C, a data filter unit 3D, and a data transmission/reception unit 3E.

The first zone ECU 5a functionally includes a disconnection detection unit 5aA, a communication path switching unit 5aB, a data filter unit 5aC, a data conversion unit 5aD, and a data transmission/reception unit 5aE. Similarly, the second zone ECU 5b functionally includes a disconnection detection unit 5bA, a communication path switching unit 5bB, a data filter unit 5bC, a data conversion unit 5bD, and a data transmission/reception unit 5bE.

The functions of each component will be described below. The application processing unit 3A has functions such as mobility computer functionality for exchanging data with each terminal ECU 7.

The disconnection detection units 3B, 5aA, and 5bA have the function of detecting communication disconnection of the main communication line 11 (for example, the first and second main communication lines 11a, 11b). Among these, the disconnection detection units 5aA and 5bA have the function of detecting communication disconnection of the redundant communication line 13 (for example, the first and second redundant communication lines 13a, 13b).

The communication path switching units 3C, 5aB, and 5bB have the function of switching to a communication path using the redundant communication line 13 when communication on the main communication line 11 is disconnected. The data filter units 3D, 5aC, and 5bC have the function, when communication is disconnected, of determining whether the data requested for transmission is disconnection transmission target data (i.e., data to be transmitted during disconnection), and, if it is disconnection transmission target data, reducing the information amount (i.e., data amount) as necessary (i.e., thinning out the data).

The data conversion units 5aD and 5bD have the function, when communication on the main communication line 11 is disconnected, of changing the data amount according to the communicable data amount of the redundant communication line 13 and transmitting data with consideration of priority information.

The data transmission/reception units 3E, 5aE, and 5bE have the function of transmitting and receiving data. Each terminal ECU 7 has the function of exchanging data with the mobility computer 3 via each zone ECU 5.

### 1-4. Control Processing

Next, control processing executed in the communication system 1 will be described.

### First Control Processing

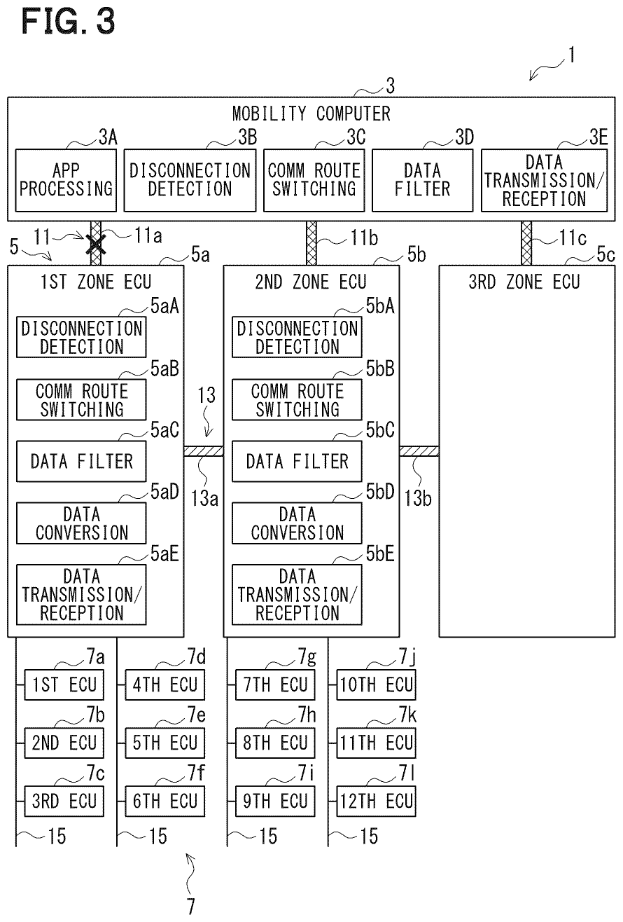

First, as shown in FIG. 3, processing when communication disconnection occurs on the first main communication line 11a between the mobility computer 3 and the first zone ECU 5a will be described. In FIG. 3, the location where communication is disconnected is indicated by an X mark. Here, the processing up to switching the communication path will be described. In this processing, the processing mainly executed by the first zone ECU 5a will be explained.

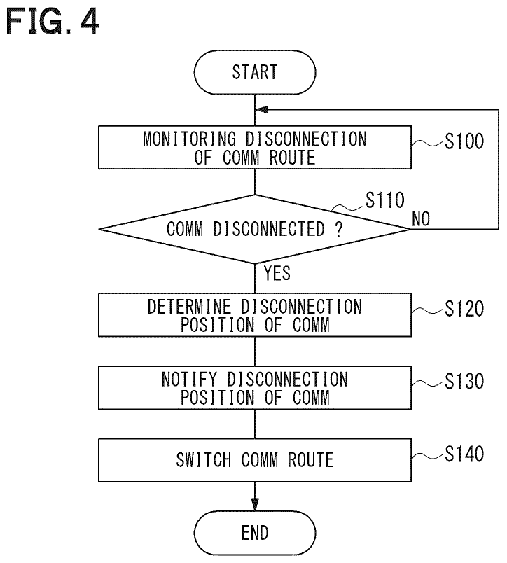

As shown in FIG. 4, in S100, the first zone ECU 5a monitors for communication disconnection of the first main communication line 11a and the first redundant communication line 13a. That is, it checks whether communication with the communication target is being performed normally. For example, it checks whether transmission and reception of predetermined data is being performed normally.

Subsequently, in S110, it is determined whether communication is disconnected. If the determination is affirmative, the process proceeds to S120. If the determination is negative, the process returns to S100. For example, if transmission and reception of predetermined data cannot be performed within a predetermined period, it can be determined that communication is disconnected.

In S120, the location of the communication disconnection is determined. For example, by detecting that communication is disconnected on the first main communication line 11a (see FIG. 3) or the first redundant communication line 13a, the location of the communication disconnection can be determined.

Subsequently, in S130, the location of the communication disconnection is notified to each terminal ECU 7. For example, when communication is disconnected on the first main communication line 11a, the first zone ECU 5a notifies the second zone ECU 5b and the first to sixth terminal ECUs 7a to 7f of the communication disconnection and the location of the communication disconnection. That is, it notifies where the communication disconnection occurred.

This notification may employ broadcast notification, so the notification content is also communicated to devices (i.e., nodes) connected to the second zone ECU 5b and the like. For example, the mobility computer 3 and the third zone ECU 5c are also notified.

Subsequently, in S140, processing to switch the communication path is performed, and this processing is temporarily ended. The processing for switching the communication path will be described in detail later. For example, when communication is disconnected on the first main communication line 11a, a path (i.e., backup path) using the second main communication line 11b and the first redundant communication line 13a, which are not disconnected, is set, and processing is performed so that data transmission and reception can be performed via the backup path.

Additionally, apart from the above, the mobility computer 3 may detect communication disconnection of the main communication line 11. For example, when the mobility computer 3 detects communication disconnection of the first main communication line 11a, the detected content may be notified by broadcast via the second and third main communication lines 11b and 11c.

Then, as described above, when the location of the communication disconnection is notified, for example, if the notified party (i.e., node in the network) stores a routing table including information on the shortest path, the routing table can be updated based on the notified content.

### Second Control Processing

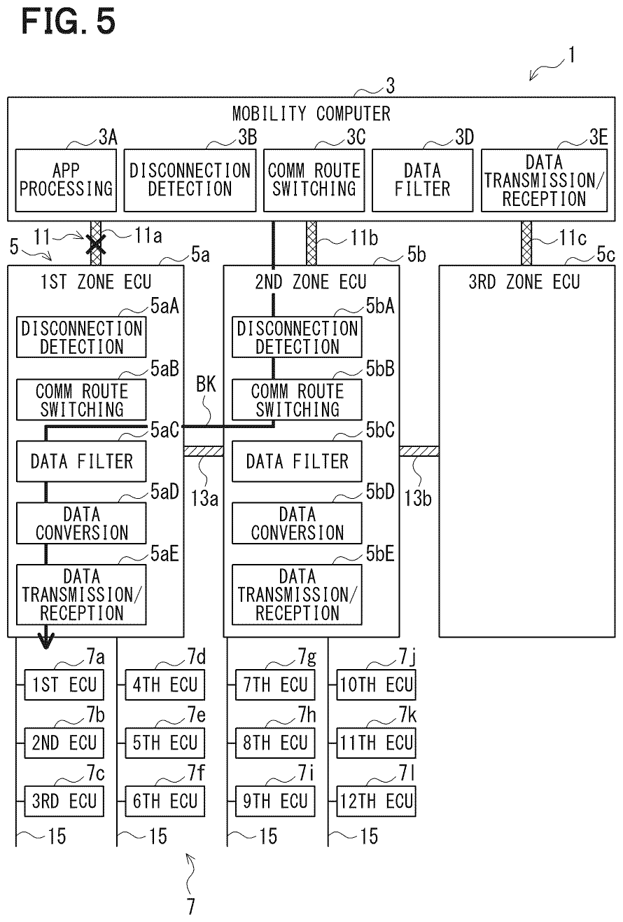

Next, as shown in FIG. 5, when communication disconnection occurs on the first main communication line 11a between the mobility computer 3 and the first zone ECU 5a, the communication path prior to disconnection (i.e., during normal operation) is switched to a backup path BK. For example, a method for transmitting data from the mobility computer 3 to the first terminal ECU 7a will be described. FIG. 5 is an explanatory diagram corresponding to the second control process.

During normal operation (i.e., when communication is not disconnected), the communication path for transmitting data from the mobility computer 3 to the first terminal ECU 7a is:
“Mobility computer 3→first main communication line 11a→first zone ECU 5a→terminal communication line 15→first terminal ECU 7a.”

During normal operation, for example, when transmitting data from the mobility computer 3 to the first terminal ECU 7a, the mobility computer 3 first transmits a communication frame containing the data to be transmitted to the first zone ECU 5a. This communication frame includes destination data (i.e., address information), and the first terminal ECU 7a that receives this communication frame can refer to its stored routing table (i.e., data including the shortest transmission path and other information) and transmit this communication frame to the transmission destination, which is the first zone ECU 5a.

On the other hand, when communication disconnection occurs on the first main communication line 11a, the backup path BK set (i.e., the path indicated by the bold solid line in FIG. 5) is:
“Mobility computer 3→second main communication line 11b→second zone ECU 5b→first redundant communication line 13a→first zone ECU 5a→terminal communication line 15→first terminal ECU 7a.”

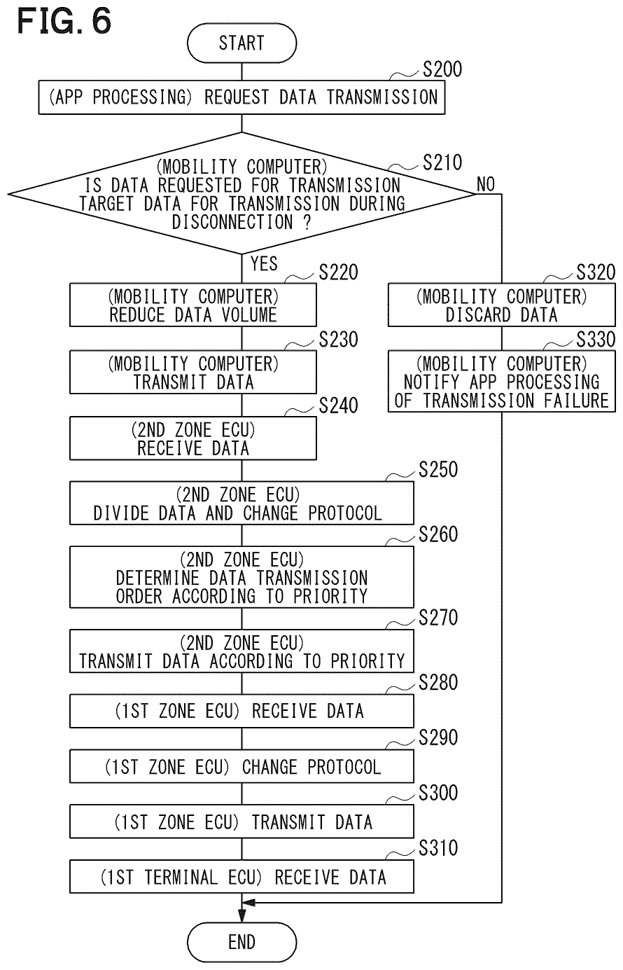

Next, as shown in FIG. 6, when communication disconnection occurs on the first main communication line 11a, processing for transmitting data from the mobility computer 3 to the first terminal ECU 7a via the backup path BK, specifically, processing for transmitting a communication frame containing the data to be transmitted, will be described.

As shown in FIG. 6, first, in S200, the application processing unit 3A requests data transmission. The request is processed by the mobility computer control unit 21, and processing for transmitting data from the mobility computer 3 to the transmission target (for example, the first ECU 7a) is started.

In S210, it is determined whether the data is disconnection transmission target data. The disconnection transmission target data refers to data that needs to be transmitted when communication via the first main communication line 11a is disconnected. The type of data that needs to be transmitted in the event of communication disconnection (for example, depending on the timing such as driving state) can be set in advance. If the determination is affirmative, the process proceeds to S220. If negative, the process proceeds to S320.

If it is determined to be disconnection transmission target data, the data to be transmitted via the backup path BK is stored, for example, in a first table for disconnection transmission target data. For example, the type of data and the value of the data itself are stored. If there are multiple types of disconnection transmission target data (for example, vehicle speed data, temperature data, etc.), each can be stored in the first table.

In S320, since the data is not disconnection transmission target data, the data is discarded and the process proceeds to S330. In S330, notification that transmission was not possible is sent to the application processing unit 3A, and this processing is temporarily ended.

On the other hand, in S220, since the data is disconnection transmission target data, processing is performed to reduce the data amount (i.e., thinning out the data), considering that the data cannot be transmitted via the high-speed first main communication line 11a. That is, processing to reduce the data communication amount is performed.

Examples of processing to reduce the data amount include reducing the number of digits of quantitative data. For example, if the data has two decimal places, processing may be performed to reduce it to one decimal place. In the case of image data, the number of pixels to be transmitted may be reduced, or color information may be reduced (for example, reducing the number of colors).

The data after thinning out (i.e., the actual data to be transmitted) is stored, for example, in a second table. In S230, the mobility computer 3 transmits the above data (i.e., data with reduced data amount) to the second zone ECU 5b via the second main communication line 11b, which is not disconnected.

The mobility computer 3 has information on how the mobility computer 3, each zone ECU 5, and each terminal ECU 7 are communicably connected. Specifically, the mobility computer 3 has information on which zone ECU 5 should be used to transmit data to reach the intended terminal ECU 7 via the shortest path (for example, a path with the fewest relay devices, i.e., nodes). Therefore, for example, when transmitting data from the mobility computer 3 to the first terminal ECU 7a, the mobility computer 3 transmits the data to the second zone ECU 5b via the second main communication line 11b.

In subsequent S240, the second zone ECU 5b receives the data (i.e., data with reduced data amount) transmitted from the mobility computer 3. In S250, the second zone ECU 5b segments the data according to the frame payload size suitable for the first redundant communication line 13a, which has a lower transmission speed, and modifies the protocol accordingly. In other words, the data amount in the communication frame used for transmission is reduced.

In S260, the second zone ECU 5b determines the transmission order of the data according to priority information. For example, if there are multiple types of data to be transmitted (i.e., disconnection transmission target data), data with higher priority is transmitted first (i.e., with an earlier transmission order).

The priority information may be preset according to the type of data. For example, if there are speed data and temperature data, since speed data is considered to change more frequently, the priority of speed data can be set higher than that of temperature data. If the communication frame includes priority information for transmission, the transmission order may be set based on that priority information. For example, in Ethernet, priority can be set using methods such as DSCP. DSCP stands for Differentiated Services Code Point.

In S270, the second zone ECU 5b transmits the data to the first zone ECU 5a according to the priority information. Since the second zone ECU 5b stores the aforementioned routing table, if the transmission destination is, for example, the first terminal ECU 7a, the data can be transmitted to the adjacent node, the first zone ECU 5a, set according to the shortest path based on the transmission destination data (e.g., destination address).

In S280, the first zone ECU 5a receives the data from the second zone ECU 5b. In S290, the first zone ECU 5a changes the protocol to transmit the data via CAN over the terminal communication line 15.

In S300, the first zone ECU 5a transmits the data to the first terminal ECU 7a via the terminal communication line 15. Since the first zone ECU 5a stores the aforementioned routing table, if the transmission destination is, for example, the first terminal ECU 7a, it can transmit the data to the first terminal ECU 7a based on the transmission destination data.

In S310, the first terminal ECU 7a receives the data transmitted from the first zone ECU 5a, and this processing is ended for now.

### Third Control Processing

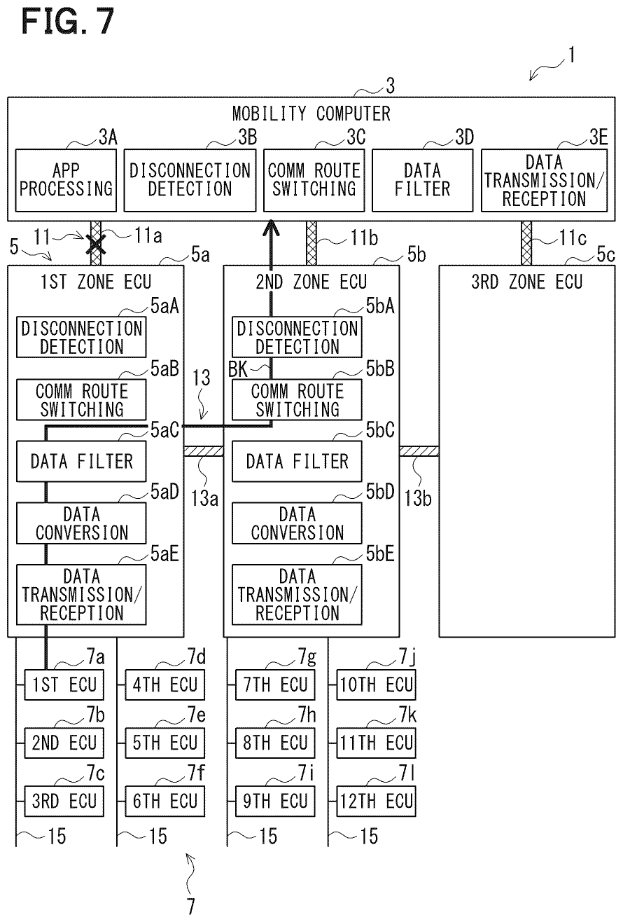

Next, as shown in FIG. 7, when communication disconnection occurs on the first main communication line 11a between the mobility computer 3 and the first zone ECU 5a, the communication path prior to disconnection (i.e., during normal operation) is switched to the backup path BK, and a method for transmitting data from the first terminal ECU 7a to the mobility computer 3 will be described. FIG. 7 is an explanatory diagram corresponding to the third control process.

In such a case, the backup path BK is:
“First terminal ECU 7a→terminal communication line 15→first zone ECU 5a→first redundant communication line 13a→second zone ECU 5b→second main communication line 11b→mobility computer 3.”

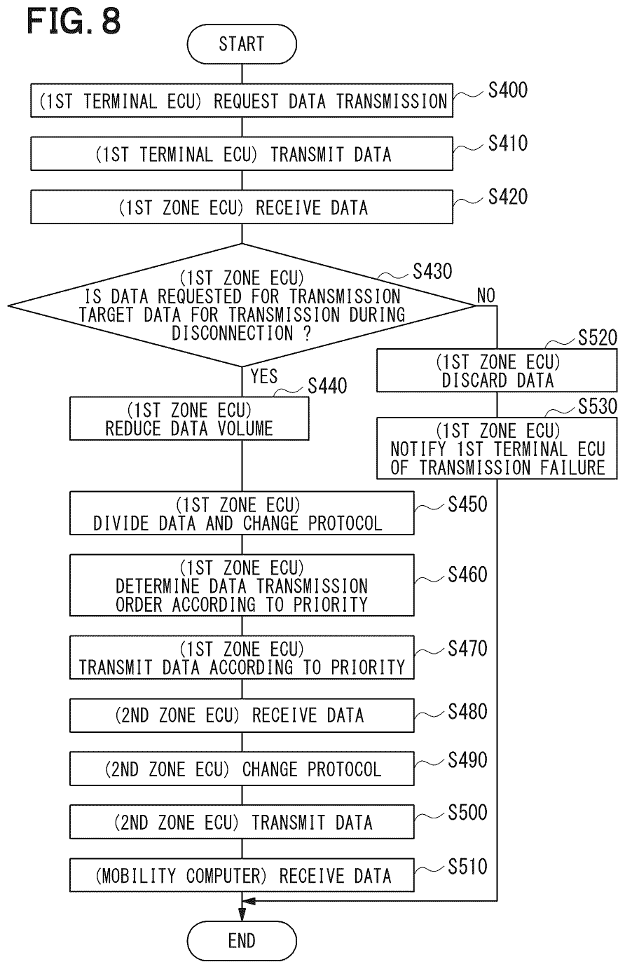

Here, as shown in FIG. 8, when communication disconnection occurs on the first main communication line 11a, processing for transmitting data from the first terminal ECU 7a to the mobility computer 3 via the backup path BK, specifically, processing for transmitting a communication frame containing the data to be transmitted, will be described.

When communication disconnection occurs on the first main communication line 11a, it is detected by the mobility computer 3 or the first zone ECU 5a, and the information is broadcast from the mobility computer 3 or the first zone ECU 5a to each node connected to the network. Each node can receive this information and update its own routing table. Accordingly, the data transmission path can be changed in response to the communication disconnection on the first main communication line 11a.

As shown in FIG. 8, for example, in S400, the first terminal ECU 7a requests data transmission. That is, the first terminal ECU 7a requests processing to transmit data to the final transmission destination, the mobility computer 3.

In S410, the first terminal ECU 7a transmits the data (i.e., communication frame) to the first zone ECU 5a via the terminal communication line 15. In S420, the first zone ECU 5a receives the data transmitted from the first terminal ECU 7a.

In S430, the first zone ECU 5a determines whether the received data is disconnection transmission target data. If the determination is affirmative, the process proceeds to S440. If the determination is negative, the process proceeds to S520.

In S520, since the data is not disconnection transmission target data, the data is discarded and the process proceeds to S530. In S530, notification that transmission was not possible is sent to the first terminal ECU 7a, and this processing is temporarily ended.

On the other hand, if the determination in S430 is affirmative and the process proceeds to S440, since the data is disconnection transmission target data, processing is performed to reduce the data amount (i.e., thinning out the data), considering that the data will be transmitted via the first redundant communication line 13a, which has a lower transmission speed. If the data amount transmitted via the terminal communication line 15 is small, the thinning process may be omitted.

In S450, the first zone ECU 5a segments the data according to the frame payload size suitable for the first redundant communication line 13a, which has a lower transmission speed, and modifies the protocol accordingly.

In S460, the first zone ECU 5a determines the transmission order of the data according to priority information. In S470, the first zone ECU 5a transmits the data to the second zone ECU 5b according to the priority information. Since the first zone ECU 5a stores the aforementioned routing table, if the transmission destination is, for example, the mobility computer 3, the data can be transmitted to the adjacent node, the second zone ECU 5b, set according to the shortest path based on the transmission destination data (e.g., destination address).

In S480, the second zone ECU 5b receives the data from the first zone ECU 5a. In S490, the second zone ECU 5b changes the protocol to transmit the data via the second main communication line 11b.

In S500, the second zone ECU 5b transmits the data to the mobility computer 3 via the second main communication line 11b. Since the second zone ECU 5b stores the aforementioned routing table, if the transmission destination is, for example, the mobility computer 3, it can transmit the data to the mobility computer 3 based on the transmission destination data.

In S510, the mobility computer 3 receives the data transmitted from the second zone ECU 5b, and this processing is temporarily ended.

### Fourth Control Processing

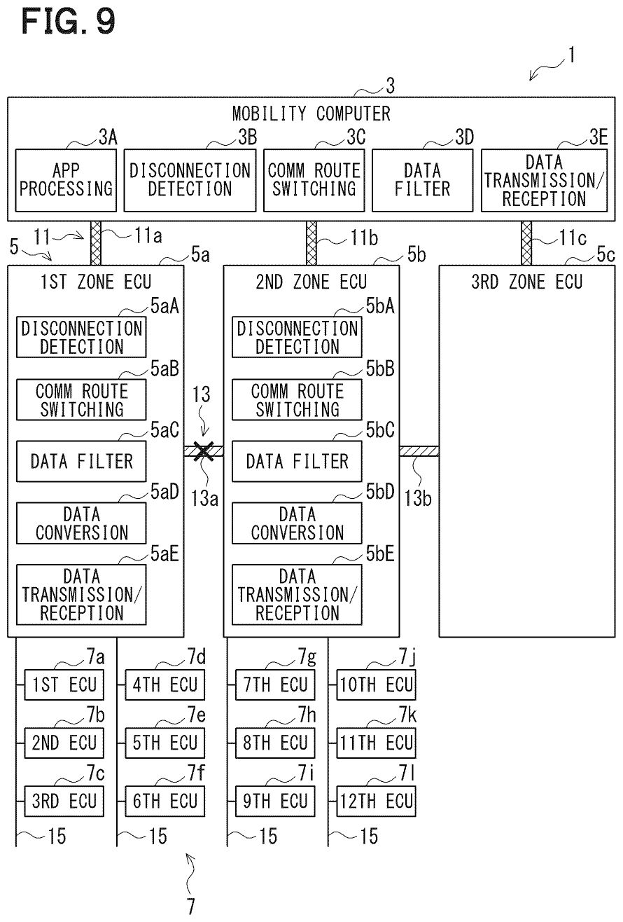

Next, as shown in FIG. 9, a case where communication disconnection occurs on the first redundant communication line 13a between the first zone ECU 5a and the second zone ECU 5b will be described. FIG. 9 is an explanatory diagram corresponding to the fourth control process.

When communication disconnection occurs on the first redundant communication line 13a, it is detected by the first zone ECU 5a or the second zone ECU 5b. The information is then broadcast from the first zone ECU 5a or the second zone ECU 5b to each node connected to the network, so each node can receive this information and update its own routing table.

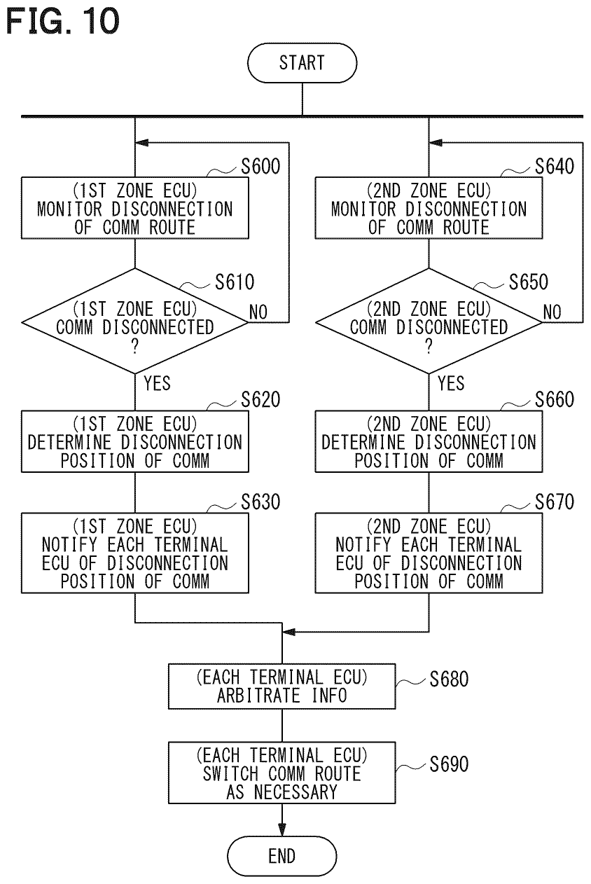

As shown in FIG. 10, for example, in S600, the first zone ECU 5a monitors for communication path disconnection. In S610, it is determined whether there is a communication path that is disconnected. If the determination is affirmative, the process proceeds to S620. If the determination is negative, the process returns to S600.

In S620, the location of the communication disconnection is determined. In S630, the communication disconnection and its location are notified to each terminal ECU 7. The same notification may also be sent to the mobility computer 3.

Similarly, for example, in S640, the second zone ECU 5b monitors for communication path disconnection. In S650, it is determined whether there is a communication path that is disconnected. If the determination is affirmative, the process proceeds to S660. If the determination is negative, the process returns to S640.

In S660, the location of the communication disconnection is determined. In S670, the communication disconnection and its location are notified to each terminal ECU 7. The same notification may also be sent to the mobility computer 3.

Then, as processing after S630 and S640, in S680, each terminal ECU 7 selects the information. That is, since various information (for example, information on which communication path is disconnected) is transmitted from the mobility computer 3, the first zone ECU 5a, the second zone ECU 5b, etc., each terminal ECU 7 adopts the information received first.

In subsequent S680, each terminal ECU 7 switches the communication path as necessary, and this processing is temporarily ended. For example, considering the case where data is transmitted from each terminal ECU 7 to the mobility computer 3, even if communication disconnection occurs on the first redundant communication line 13a, the same communication path as during normal operation can be adopted. For example, when transmitting data from the first terminal ECU 7a to the mobility computer 3, the data can be transmitted from the first zone ECU 5a to the mobility computer 3 via the first main communication line 11a without using the first redundant communication line 13a.

Similarly, when transmitting data from the seventh terminal ECU 7g to the mobility computer 3, the data can be transmitted from the second zone ECU 5b to the mobility computer 3 via the second main communication line 11b without using the first redundant communication line 13a.

### 1-5. Effects

According to the first embodiment, the following effects may be obtained.
(1a) In the first embodiment, in the communication system 1, the mobility computer 3 and each zone ECU 5 are communicably connected via respective main communication lines 11. The first zone ECU 5a and the second zone ECU 5b are communicably connected via a first redundant communication line 13a, which has a lower transmission capability in terms of data communication amount (for example, a smaller amount of data that can be transmitted per unit time) than the main communication line 11, and the second zone ECU 5b and the third zone ECU 5c are similarly communicably connected via a second redundant communication line 13b.

When the mobility computer 3 transmits data to a zone ECU 5 as a transmission target, it is configured to transmit data via the main communication line 11 connected to that zone ECU 5, and is also configured to transmit data to the transmission target zone ECU 5 by reducing the data communication amount via a backup path BK including another main communication line 11 and a redundant communication line 13 different from the main communication line 11.

With such a configuration, in the first embodiment, it is possible to transmit data to a transmission target via a main communication line 11, and also to transmit data to the same transmission target via a redundant communication line 13. Further, when transmitting data via the redundant communication line 13, it is possible to transmit the data with a reduced data communication amount. Furthermore, since data can be transmitted to the transmission target via both the main communication line 11 and the redundant communication line 13, even if communication via a main communication line 11 is disconnected, data can be transmitted via the redundant communication line 13.
(1b) In the first embodiment, in order to detect communication disconnection of the main communication line 11 between the mobility computer 3 and each zone ECU 5, the mobility computer 3 is provided with a disconnection detection unit 3B, and each zone ECU 5 is provided with disconnection detection units 5aA and 5bA. When communication disconnection of the main communication line 11 is detected by the disconnection detection units 3B, 5aA, and 5bA, data can be transmitted via a backup path BK including main communication lines 11 and redundant communication lines 13 other than the disconnected main communication line 11.

For example, when the disconnection detection unit 3B of the mobility computer 3 detects communication disconnection of the main communication line 11, processing for transmitting data via the backup path BK can be performed.
(1c) In the first embodiment, when transmitting data via the backup path BK, the mobility computer 3 and each zone ECU 5 can reduce the information amount (i.e., data amount) of the data to be transmitted. Therefore, even if the transmission capability of the redundant communication line 13 is low, necessary data (for example, data necessary for vehicle driving control, etc.) can be transmitted at an appropriate timing, albeit with a smaller data amount.
(1d) In the first embodiment, when transmitting data via the backup path BK, the mobility computer 3 and each zone ECU 5 can be configured not to transmit data if the data to be transmitted is not disconnection transmission target data to be transmitted in the event of communication disconnection. This suppresses the transmission of data with low necessity and enables necessary data to be transmitted at an appropriate timing.
(1e) In the first embodiment, when each zone ECU 5 transmits data via the redundant communication line 13, the data can be segmented and transmitted according to the data communication amount that can be transmitted via the redundant communication line 13.
(1f) In the first embodiment, when each zone ECU 5 transmits data via the redundant communication line 13, the data can be transmitted based on priority information specifying the transmission priority included in the data to be transmitted. This enables necessary data to be transmitted preferentially.
(1g) In the first embodiment, when each zone ECU 5 transmits data via the redundant communication line 13, the data can be transmitted according to a predetermined transmission priority set in advance depending on the situation of communication disconnection. This enables necessary data to be transmitted preferentially.

### 1-6. Correspondence

Next, the relationship between the present disclosure and the first embodiment will be described.

The communication system corresponds to the communication system 1, the first electronic control device corresponds to the mobility computer 3, the second electronic control device corresponds to each zone ECU 5, the main path corresponds to each main communication line 11, and the redundant path corresponds to each redundant communication line 13.

### 2. Second Embodiment

Since the basic configuration of the second embodiment is similar to that of the first embodiment, the following description will mainly focus on the differences from the first embodiment. Note that the same reference numerals as in the first embodiment indicate identical components, and reference should be made to the preceding description.

In the second embodiment, the configuration of the communication system differs from that of the first embodiment, so the explanation will focus on the differences.

### 2-1. Configuration

The communication system of the second embodiment is based on a domain architecture, and uses a plurality of electronic control devices classified into multiple domains (i.e., divided by function).

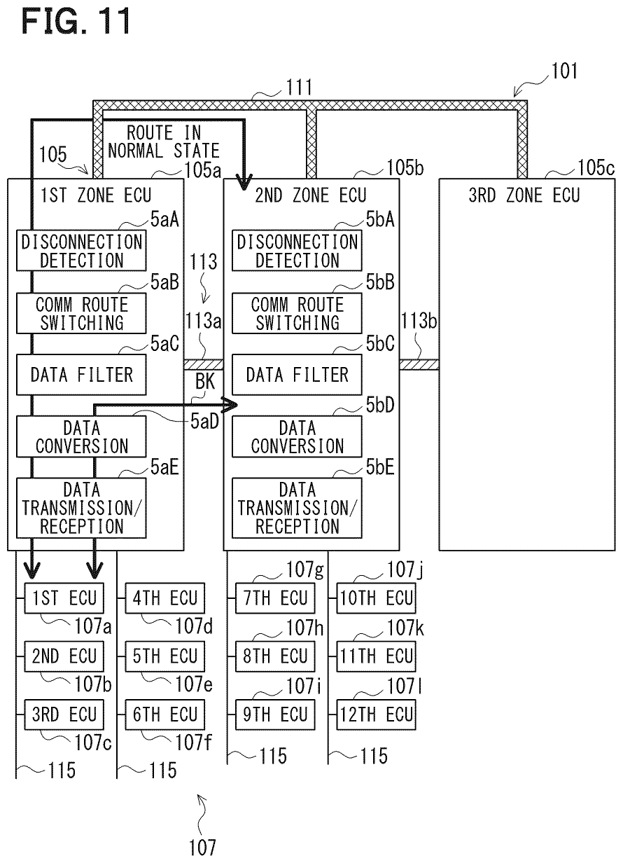

As shown in FIG. 11, the communication system 101 of this embodiment comprises a plurality of domain ECUs 105 and a plurality of terminal ECUs 107, each communicably connected to the respective domain ECUs 105.

Among the plurality of domain ECUs 105, the first domain ECU 105a, the second domain ECU 105b, and the third domain ECU 105c are communicably connected by main communication lines 111 similar to those in the first embodiment.

The first domain ECU 105a and the second domain ECU 105b are communicably connected by a first redundant communication line 113a, which is a redundant communication line 113 similar to that in the first embodiment. The second domain ECU 105b and the third domain ECU 105c are communicably connected by a similar second redundant communication line 113b.

Hereinafter, the case where the first domain ECU 105a and the second domain ECU 105b are used will be described as an example. Each domain ECU 105 and each terminal ECU 107 are connected by terminal communication lines 115 similar to those in the first embodiment.

The functional configuration of each domain ECU 105, namely, the disconnection detection unit, communication path switching unit, data filter unit, data conversion unit, and data transmission/reception unit, is the same as in the first embodiment.

### 2-2. Operation and Effects

The second embodiment provides effects similar to those of the first embodiment. In the second embodiment, for example, if communication disconnection occurs between the first domain ECU 105a and the second domain ECU 105b on the main communication line 111, data transmission and reception between the first to sixth terminal ECUs 107a to 107f and the second domain ECU 105b can be performed using a backup path BK employing the first redundant communication line 111a instead of the normal path.

### 3. Third Embodiment

Since the basic configuration of the third embodiment is similar to that of the first embodiment, the following description will mainly focus on the differences from the first embodiment. Note that the same reference numerals as in the first embodiment indicate identical components, and reference should be made to the preceding description.

### 3-1. Configuration

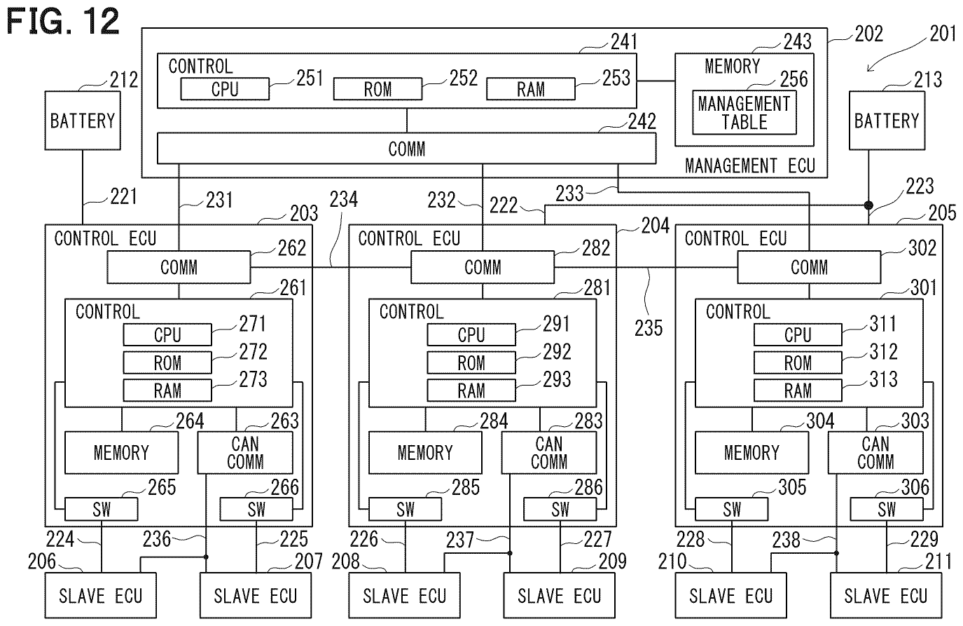

In the third embodiment, as shown in FIG. 12, the in-vehicle communication system 201 comprises a management ECU 202, control ECUs 203, 204, 205, slave ECUs 206, 207, 208, 209, 210, 211, and batteries 212, 213.

The management ECU 202 realizes coordinated control of the entire vehicle by supervising the control ECUs 203, 204, 205. The control ECUs 203, 204, 205 are provided for each zone into which the vehicle is divided, and mainly control the slave ECUs present in their respective zones.

Slave ECUs 206, 207 belong to the same zone as control ECU 203. Slave ECUs 208, 209 belong to the same zone as control ECU 204. Slave ECUs 210, 211 belong to the same zone as control ECU 205.

Batteries 212, 213 supply power to various parts of the vehicle at a DC battery voltage (for example, 12V). Control ECU 203 receives power supply from battery 212 via a power supply path 221 between battery 212 and control ECU 203. Control ECU 204 receives power supply from battery 213 via a power supply path 222 between battery 213 and control ECU 204. Control ECU 205 receives power supply from battery 213 via a power supply path 223 between battery 213 and control ECU 205.

Slave ECUs 206, 207 each receive power supply from battery 212 via power supply paths 224, 225 between control ECU 203 and slave ECUs 206, 207. Slave ECUs 208, 209 each receive power supply from battery 213 via power supply paths 226, 227 between control ECU 204 and slave ECUs 208, 209. Slave ECUs 210, 211 each receive power supply from battery 213 via power supply paths 228, 229 between control ECU 205 and slave ECUs 210, 211.

The management ECU 202 and control ECU 203 are communicably connected via communication line 231. The management ECU 202 and control ECU 204 are communicably connected via communication line 232. The management ECU 202 and control ECU 205 are communicably connected via communication line 233.

Control ECU 203 and control ECU 204 are communicably connected to each other via communication line 234. Control ECU 204 and control ECU 205 are communicably connected to each other via communication line 235. Control ECU 203 and slave ECUs 206, 207 are communicably connected to each other via communication line 236.

Control ECU 204 and slave ECUs 208, 209 are communicably connected to each other via communication line 237. Control ECU 205 and slave ECUs 210, 211 are communicably connected to each other via communication line 238.

The management ECU 202 includes a control unit 241, a communication unit 242, and a storage unit 243. The control unit 241 is an electronic control device mainly composed of a microcomputer equipped with a CPU 51, ROM 52, RAM 53, and the like.

The communication unit 242 communicates with control ECU 203 connected via communication line 231, with control ECU 204 connected via communication line 232, and with control ECU 205 connected via communication line 233, for example, by transmitting and receiving communication frames based on the Ethernet communication protocol. Here, communication lines 231, 232, and 233 correspond to the main communication lines described above.

The storage unit 243 is a storage device for storing various types of data. The storage unit 243 stores a management table 256, which will be described later.

Control ECU 203 comprises a control unit 261, a communication unit 262, a CAN communication unit 263, a storage unit 264, and power distribution switches 265 and 266. The CAN communication unit 262 communicates using the CAN communication protocol (the same applies to other CAN communication units described below).

The control unit 261 is an electronic control device mainly composed of a microcomputer equipped with a CPU 271, ROM 272, RAM 273, and the like. The communication unit 262 communicates with the management ECU 202 connected via communication line 231, for example, by transmitting and receiving communication frames based on the Ethernet communication protocol. The communication unit 262 may also transmit and receive communication frames with control ECU 204 connected via communication line 234, for example, based on the Ethernet or CAN communication protocol. Here, communication line 234 may be the aforementioned redundant communication line, which has a lower transmission capability than the main communication line.

The CAN communication unit 263 communicates with slave ECUs 206, 207 connected via communication line 236 by transmitting and receiving communication frames based on the CAN communication protocol.

The storage unit 264 is a storage device for storing various types of data. The power distribution switch 265 is disposed on the power supply path 224, which is connected to the power supply path 221. The power distribution switch 265 is configured to conduct or interrupt the power supply path 224 according to commands from the control unit 261.

The power distribution switch 266 is disposed on the power supply path 225, which is connected to the power supply path 221. The power distribution switch 266 is configured to conduct or interrupt the power supply path 225 according to commands from the control unit 261.

Control ECU 204 comprises a control unit 281, a communication unit 282, a CAN communication unit 283, a storage unit 284, and power distribution switches 285 and 286. The control unit 281 is an electronic control device mainly composed of a microcomputer equipped with a CPU 291, ROM 292, RAM 293, and the like.

The communication unit 282 communicates with the management ECU 202 connected via communication line 232, for example, by transmitting and receiving communication frames based on the Ethernet communication protocol. The communication unit 282 may also transmit and receive communication frames with control ECU 203 connected via communication line 234 and with control ECU 205 connected via communication line 235, for example, based on the Ethernet or CAN communication protocol. Here, communication line 235 may be the aforementioned redundant communication line, which has a lower transmission capability than the main communication line.

The CAN communication unit 283 communicates with slave ECUs 208, 209 connected via communication line 237 by transmitting and receiving communication frames based on the CAN communication protocol.

The storage unit 284 is a storage device for storing various types of data. The power distribution switch 285 is disposed on the power supply path 226, which is connected to the power supply path 222. The power distribution switch 285 is configured to conduct or interrupt the power supply path 226 according to commands from the control unit 281.

The power distribution switch 286 is disposed on the power supply path 227, which is connected to the power supply path 222. The power distribution switch 286 is configured to conduct or interrupt the power supply path 227 according to commands from the control unit 281.

Control ECU 205 comprises a control unit 301, a communication unit 302, a CAN communication unit 303, a storage unit 304, and power distribution switches 305 and 306. The control unit 301 is an electronic control device mainly composed of a microcomputer equipped with a CPU 311, ROM 312, RAM 313, and the like.

The communication unit 302 communicates with the management ECU 202 connected via communication line 233, for example, by transmitting and receiving communication frames based on the Ethernet communication protocol. The communication unit 302 may also transmit and receive communication frames with control ECU 204 connected via communication line 235, for example, based on the Ethernet or CAN communication protocol.

The CAN communication unit 303 communicates with slave ECUs 210, 211 connected via communication line 238 by transmitting and receiving communication frames based on the CAN communication protocol.

The storage unit 304 is a storage device for storing various types of data. The power distribution switch 305 is disposed on the power supply path 228, which is connected to the power supply path 223. The power distribution switch 305 is configured to conduct or interrupt the power supply path 228 according to commands from the control unit 301.

The power distribution switch 306 is disposed on the power supply path 229, which is connected to the power supply path 223. The power distribution switch 306 is configured to conduct or interrupt the power supply path 229 according to commands from the control unit 301.

In the management table 256, for each of a plurality of events, the correspondence between the event and the power distribution switches to be set to the on state (i.e., the state in which the power supply path is conducted) and the power distribution switches to be set to the off state (i.e., the state in which the power supply path is interrupted) is set.

Specifically, in the management table 256, for each event, six switching pieces of information indicating whether each of the power distribution switches 265, 266, 285, 286, 305, and 306 should be set to the on state or the off state are set.

When the management ECU 202 detects an event, it extracts from the management table 256 the six switching pieces of information corresponding to the detected event. The management ECU 202 then generates a communication frame including the extracted six switching pieces of information as an NM frame and transmits the generated NM frame. NM stands for Network Management.

When control ECU 203 receives the NM frame transmitted by the management ECU 202, it extracts the switching information for the subordinate power distribution switches 265 and 266 from the NM frame and, based on the extracted switching information, sets the power distribution switches 265 and 266 to the on state or the off state.

When control ECU 204 receives the NM frame transmitted by the management ECU 202, it extracts the switching information for the subordinate power distribution switches 285 and 286 from the NM frame and, based on the extracted switching information, sets the power distribution switches 285 and 286 to the on state or the off state.

When control ECU 205 receives the NM frame transmitted by the management ECU 202, it extracts the switching information for the subordinate power distribution switches 305 and 306 from the NM frame and, based on the extracted switching information, sets the power distribution switches 305 and 306 to the on state or the off state.

### 3-2. Processing

### Frame Transmission Processing

Next, the procedure of the frame transmission processing executed by the control unit 241 of the management ECU 202 will be described. The frame transmission processing is repeatedly executed during the operation of the management ECU 202.

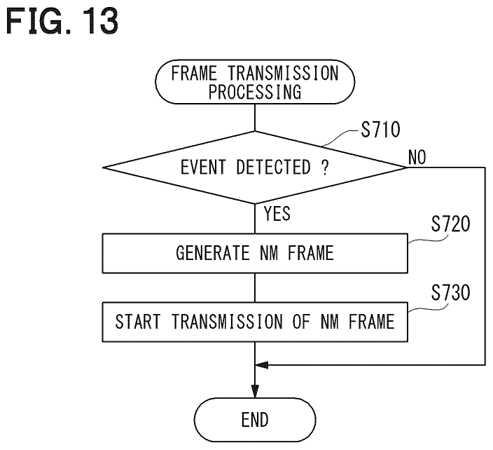

As shown in FIG. 13, when the frame transmission processing is executed, the CPU 251 of the control unit 241 determines in S710 whether an event has been detected. If no event is detected, the CPU 251 ends the frame transmission processing.

On the other hand, if an event is detected, the CPU 251, in S720, extracts from the management table 256 the six switching pieces of information corresponding to the detected event and generates an NM frame including the extracted six switching pieces of information.

In S730, the CPU 251 starts processing to transmit the NM frame generated in S720 to control ECUs 203, 204, and 205 via communication lines 231, 232, and 233, respectively, and ends the frame transmission processing. As a result, the management ECU 202 periodically and repeatedly transmits the NM frame generated in S720.

### Frame Forwarding Processing

Next, the procedure of the frame forwarding processing executed by the control units 261, 281, and 301 of control ECUs 203, 204, and 205 will be described. The frame forwarding processing is repeatedly executed during the operation of control ECUs 203, 204, and 205.

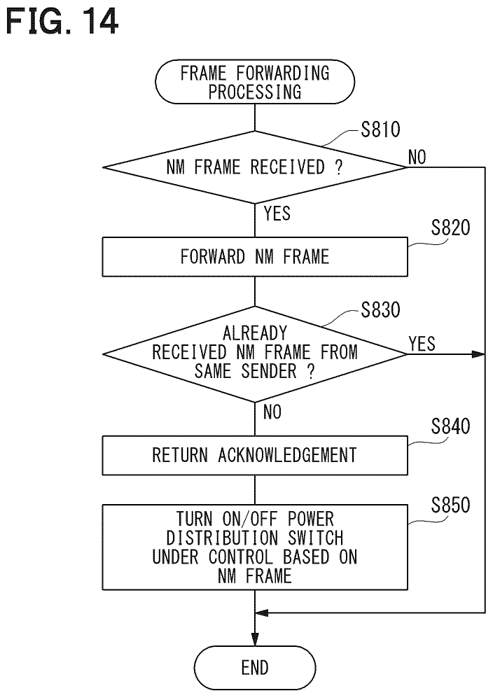

When the frame forwarding processing is executed, as shown in FIG. 14, the CPUs 271, 291, and 311 of the control units 261, 281, and 301 determine in S810 whether an NM frame has been received. If an NM frame has not been received, the CPUs 271, 291, and 311 end the frame forwarding processing.

On the other hand, if an NM frame has been received, the CPUs 271, 291, and 311, in S820, forward the received NM frame via the remaining communication lines, excluding the communication lines 231, 232, and 233 connected to the management ECU 202 and the communication line on which the NM frame was received in S810.

For example, when control ECU 203 receives an NM frame from the management ECU 202 via communication line 231, it forwards the NM frame to control ECU 204 via communication line 234.

For example, when control ECU 203 receives an NM frame from control ECU 204 via communication line 234, it does not forward the NM frame. When the control ECU 204 receives an NM frame from the management ECU 202 via communication line 232, it forwards the NM frame to control ECUs 203 and 205 via communication lines 234 and 235, respectively.

For example, when control ECU 204 receives an NM frame from control ECU 203 via communication line 234, it forwards the NM frame to control ECU 205 via communication line 235.

For example, when control ECU 204 receives an NM frame from control ECU 205 via communication line 235, it forwards the NM frame to control ECU 203 via communication line 234.

For example, when control ECU 205 receives an NM frame from the management ECU 202 via communication line 233, it forwards the NM frame to control ECU 204 via communication line 235.

For example, when control ECU 205 receives an NM frame from control ECU 204 via communication line 235, it does not forward the NM frame. In S830, the CPUs 271, 291, and 311 determine, within a predetermined reception determination period from the time the NM frame was received in S810 (hereinafter, the identical frame reception determination period), whether an NM frame from the same sender (i.e., management ECU 202) has already been received. Note that the NM frame includes a sender address indicating the sender.

The identical frame reception determination period is set based on the difference in timing of receiving NM frames via multiple communication lines when a control ECU receives NM frames via multiple communication lines.

For example, in control ECU 204, the identical frame reception determination period is set based on the timing differences of receiving NM frames via communication line 231, via communication lines 232 and 234, and via communication lines 233, 234, and 235. The identical frame reception determination period may be the same or different among control ECUs 203, 204, and 205.

If an NM frame from the same sender has already been received within the identical frame reception determination period, the CPUs 271, 291, and 311 end the frame forwarding processing. On the other hand, if an NM frame from the same sender has not been received within the identical frame reception determination period, the CPUs 271, 291, and 311, in S840, return an acknowledgment via the communication line on which the NM frame was received in S810.

For example, when control ECU 204 receives an NM frame from the management ECU 202 via communication line 232, it returns an acknowledgment to the management ECU 202 via communication line 232. Also, when control ECU 204 receives an NM frame from control ECU 203 via communication line 234, it returns an acknowledgment to control ECU 203 via communication line 234.

In S850, the CPUs 271, 291, and 311 set the subordinate power distribution switches to the on state or off state based on the switching information included in the NM frame received in S810, and end the frame forwarding processing.

### Failure Detection Processing

Next, the procedure of the failure detection processing executed by the control units 261, 281, and 301 of control ECUs 203, 204, and 205 will be described. The failure detection processing is repeatedly executed during the operation of control ECUs 203, 204, and 205.

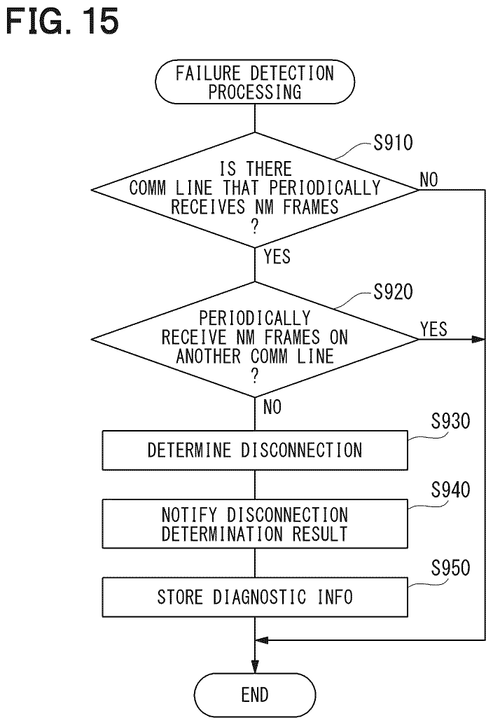

When the failure detection processing is executed, as shown in FIG. 15, the CPUs 271, 291, and 311 of the control units 261, 281, and 301 determine in S910 whether there is currently a communication line on which NM frames are being received periodically. If there is no communication line on which NM frames are being received periodically at present, the CPUs 271, 291, and 311 end the failure detection processing.

On the other hand, if there is currently a communication line on which NM frames are being received periodically, the CPUs 271, 291, and 311 determine in S220 whether NM frames are also being received periodically at present on other communication lines than the one identified in S910.

If NM frames are also being received periodically at present on other communication lines than the one identified in S910, the CPUs 271, 291, and 311 end the failure detection processing. On the other hand, if NM frames are not being received periodically at present on other communication lines than the one identified in S910, the CPUs 271, 291, and 311 determine in S930 that a communication disconnection has occurred on the communication line where NM frames are not being received periodically at present.

For example, if communication line 232 is disconnected, control ECU 204 periodically receives NM frames from control ECUs 203 and 205 via communication lines 234 and 235, but cannot receive NM frames from the management ECU 202 via communication line 232. Therefore, control ECU 204 determines that a communication disconnection has occurred on communication line 232.

For example, if communication line 234 is disconnected, control ECU 204 periodically receives NM frames from the management ECU 202 and control ECU 205 via communication lines 232 and 235, but cannot receive NM frames from control ECU 203 via communication line 234. Therefore, control ECU 204 determines that a communication disconnection has occurred on communication line 234.

For example, if communication line 231 is disconnected, control ECU 203 periodically receives NM frames from control ECU 204 via communication line 234, but cannot receive NM frames from the management ECU 202 via communication line 231. Therefore, control ECU 203 determines that a communication disconnection has occurred on communication line 231.

In S940, the CPUs 271, 291, and 311 notify the management ECU 202 of a disconnection determination result indicating the communication line where communication disconnection has occurred. Upon receiving the disconnection determination result, the management ECU 202 stores diagnostic information indicating the received disconnection determination result in the storage unit 243 as a fail-safe action. The management ECU 202 may also notify the vehicle occupants that a communication disconnection has occurred.

In S850, the CPUs 271, 291, and 311 store the diagnostic information indicating the disconnection determination result notified in S840 in the storage units 264, 284, and 304, and end the failure detection processing. Note that this failure detection processing may be omitted if the communication partner control ECU is in a sleep state.

### 3-3. Effects

(3a) In the third embodiment, even if the management ECU 202 cannot transmit NM frames to control ECU 203 via communication line 231, the management ECU 202 can transmit NM frames to control ECU 203 via communication lines 232 and 234. Also, even if the management ECU 202 cannot transmit NM frames to control ECU 204 via communication line 232, the management ECU 202 can transmit NM frames to control ECU 204 via communication lines 231 and 234. Therefore, it is possible to suppress the inability to switch between permitting and prohibiting power supply to slave ECUs 206 and 208.
(3b) In the third embodiment, control ECU 203 is configured to transmit NM frames received from the management ECU 202 to control ECU 204 via communication line 234, even if communication line 232 can be used. Control ECU 204 is configured to transmit NM frames received from the management ECU 202 to control ECU 203 via communication line 234, even if communication line 231 can be used. Therefore, control ECUs 203 and 204 can transmit NM frames via communication line 234 even during normal operation when both communication lines 231 and 232 can be used.
(3c) In the third embodiment, even if communication lines 231 and 232 cannot be used, NM frames can be transmitted to control ECUs 203 and 204 via communication lines 233, 234, and 235, so it is further possible to suppress the inability to switch between permitting and prohibiting power supply to slave ECUs 206 and 208.
(3d) In the third embodiment, each of the control ECUs 203, 204, and 205 is configured to determine that a communication disconnection has occurred on a communication line 231-235 on which NM frames are not being received periodically, provided that at least one of the communication lines 231-235 connected to the respective control ECU is receiving management frames periodically, and at least one of the communication lines 231-235 connected to the respective control ECU is not receiving NM frames periodically. With this configuration, it is possible to identify the abnormal communication line 231-235.
(3e) In the third embodiment, it is possible for the management ECU 202 to recognize the abnormal communication line 231-235.
(3f) The third embodiment provides the same effects as the first embodiment for configurations that are similar. Furthermore, in the third embodiment, since data can be transmitted to a communication target via the main communication line as well as via the redundant communication line, communication redundancy can be enhanced.

### 4. Fourth Embodiment

Since the basic configuration of the fourth embodiment is similar to that of the third embodiment, the following description will mainly focus on the differences from the first embodiment. Note that the same reference numerals as in the third embodiment indicate identical components, and reference should be made to the preceding description.

In the third embodiment described above, the management ECU 202 is configured to transmit NM frames to each of the multiple communication lines 231-233, and the control ECUs 203, 204, and 205 relay NM frames to each other. In contrast, in the fourth embodiment, the communication path (for example, the normally used communication path) to be used for each communication target is predetermined, and the management ECU 202 transmits NM frames only to the one communication line 231-233 corresponding to the communication path set for the specified communication target. The NM frame is then relayed according to the communication path, which is a point of difference from the third embodiment.

### 4-1. Configuration

As described above, in the communication system 201 of the fourth embodiment, the communication path is predetermined for each communication target. Specifically, the storage unit 243 of the management ECU 202 and the storage units 264, 284, and 304 of the control ECUs 203, 204, and 205 store, in a rewritable manner, information regarding the communication path to be used for each communication target. Information regarding the communication path refers to information necessary for communication along the designated communication path, such as information about the corresponding port for each communication line 231- 238 to be used for each communication target.

The communication paths between each device constituting the acommunication system 201 (i.e., the management ECU 202, control ECUs 203, 204, 205, and slave ECUs 206-211) are basically set so that the number of hops is minimized. For example, the communication path from the management ECU 202 to slave ECU 206 is set to communicate in the order of communication line 231, control ECU 203, and communication line 236. Also, for example, the communication path from slave ECU 208 to the management ECU 202 is set to communicate in the order of communication line 237, control ECU 204, and communication line 232. Further, for example, the communication path from slave ECU 206 to slave ECU 208 is set to communicate in the order of communication line 236, control ECU 203, communication line 234, control ECU 204, and communication line 237.

### 4-2. Processing

In the fourth embodiment, assuming that a communication disconnection occurs, multiple processes are provided to ensure that NM frames can be properly relayed in such cases. These processes include starting up a slave ECU and stopping a slave ECU. The process for starting up a slave ECU will be described.

First, as an example of the process for starting up a slave ECU, the process for starting up slave ECU 206 will be described. Note that the process described below is not limited to starting up slave ECU 206, but can be applied to the process of transmitting NM frames by specifying a communication target.

### Master Startup Processing

FIG. 15 is a flowchart illustrating the master startup processing. The master startup processing is started, for example, when the management ECU 202 is started, and is executed by the CPU 251 of the management ECU 202.

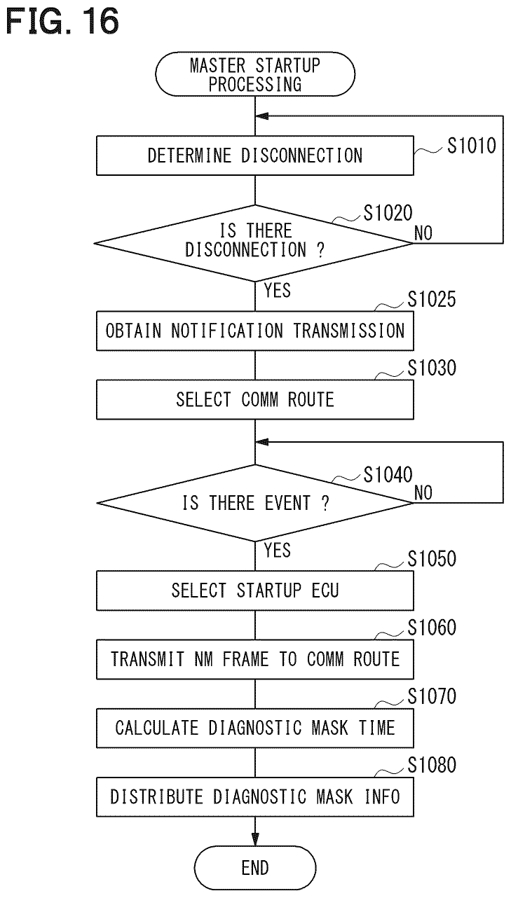

In the master startup processing, as shown in FIG. 16, first, the CPU 251 of the management ECU 202 performs a disconnection determination in S1010. This processing is the same as S930 described above. That is, in this processing, communication disconnection is detected. Note that, in this processing, abnormalities in the communication path, such as disconnection or excessive delay, may also be detected.

Subsequently, in S1020, the CPU 251 of the management ECU 202 determines whether a communication disconnection exists. If there is no communication disconnection, the process returns to S1010. If there is a communication disconnection, the process proceeds to S1025.

Subsequently, in S1025, the CPU 251 of the management ECU 202 issues an abnormality notification within the management ECU 202 regarding the detected abnormality. That is, the function for notifying abnormalities in the management ECU 202 transmits the abnormality notification, and the function for selecting the communication path in the management ECU 202 (for example, the function described in S1030 below) acquires the abnormality notification. The abnormality notification includes information for specifying the abnormal part (for example, one of the communication lines 231-235) where the abnormality has occurred among the plurality of communication paths.

Next, upon receiving the abnormality notification in S1030, the CPU 251 of the management ECU 202 selects a new communication path that avoids the abnormal part. Specifically, for example, if the communication path from the management ECU 202 to slave ECU 206 includes communication lines 231 and 236, and a communication disconnection is detected on communication line 231, a new communication path that avoids communication line 231 is established.

The management ECU 202 stores in the storage unit 243 a routing table as a set of communication path options, taking into account which devices are connected via which communication lines. For example, as a new communication path avoiding communication line 231, the management ECU 202 selects a path from the management ECU 202 via communication line 232, control ECU 204, communication line 234, control ECU 203, and communication line 236 to slave ECU 206.

The management ECU 202 stores both the new communication path and the communication path used before the abnormality was detected (also referred to as a previous communication path) in the storage unit 243. These new and previous communication paths can be read from the storage unit 243 when the management ECU 202 is restarted.

Next, in S1040, the CPU 251 of the management ECU 202 determines whether an event has occurred. The event here may be the same as the event in S710 described above, or may be another event. In one example of the fourth embodiment, it is determined whether there is an event requiring the startup of slave ECU 206. If there is no event, S1040 is repeated. If there is an event, the process proceeds to S1050.

Next, in S1050, the CPU 251 of the management ECU 202 selects the ECU to be started in accordance with the event. In one example of the fourth embodiment, slave ECU 206 is selected.

Next, in S1060, the CPU 251 of the management ECU 202 transmits an NM frame to the new communication path. This NM frame includes a configuration notification and a startup command. The configuration notification is a notification to the devices constituting the new communication path, including the plurality of control ECUs 203, 204, and 205, that communication will be conducted via the selected new communication path. The startup command is a command to start up slave ECU 206.

Next, in S1070, the management ECU 202 is configured to calculate the diagnostic mask time. The diagnostic mask time is the time until a newly joined device on the network (for example, control ECU 203) operates normally. The diagnostic mask time is calculated based on the known startup time of slave ECU 206.

Each ECU constituting the communication system 201 is configured to transmit a diagnostic (for example, error code) if communication with a target ECU is disconnected (for example, times out). In the fourth embodiment, each ECU ignores frames related to a newly joined device on the network only during the diagnostic mask time. Thus, the diagnostic mask means temporarily ignoring frames from the target ECU so that, even if communication is determined to be disconnected by any ECU, it is not regarded as abnormal.

The diagnostic mask time may be set in consideration of increased communication delay time as the communication path becomes longer. When there is no communication disconnection, the diagnostic mask time for slave ECU 206 is, for example, a value calculated based on the startup time of slave ECU 206 and the delay time on the previous communication path (for example, communication lines 231 and 236). On the other hand, when there is a communication disconnection, the diagnostic mask time is a value calculated based on the startup time of slave ECU 206 and the delay time on the new communication path (for example, including control ECU 204, communication lines 232, 234, and 236).

Each device constituting the communication system 201 may perform time synchronization, in which the timing of signal transmission and reception is determined according to a common time. In this case, time synchronization may be corrected according to the communication delay time. That is, the time held by each ECU may be corrected in consideration of the communication delay time to enable accurate synchronization. Further, the control timing may be adjusted in consideration of the communication delay time. For example, the control timing may be adjusted so that the ECU that receives the frame last receives it at the appropriate timing.

When the diagnostic mask time is set for a communication partner device in each device, signals related to the corresponding communication partner device are ignored during the diagnostic mask time. More specifically, for example, as long as the diagnostic mask time for slave ECU 206 is in effect, all devices ignore signals related to slave ECU 206.

Subsequently, in S1080, the CPU 251 of the management ECU 202 is configured to notify at least the plurality of control ECUs 203, 204, and 205 of the diagnostic mask information. The diagnostic mask information includes the diagnostic mask time. When this processing is completed, the present processing ends.

The diagnostic mask time may also be notified from control ECU 203 to slave ECUs 206 and 207, from control ECU 204 to slave ECUs 208 and 209, and from control ECU 205 to slave ECUs 210 and 211.

### Slave Startup Processing

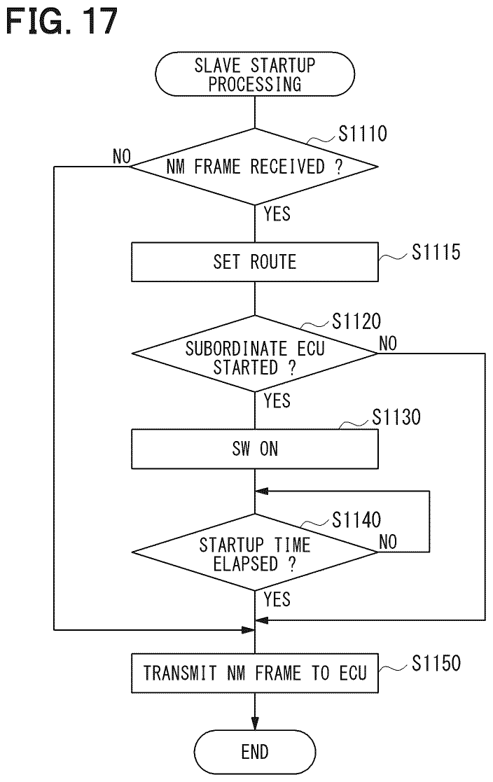

Next, FIG. 17 is a flowchart illustrating the slave startup processing executed by the CPUs 271, 291, and 311 (hereinafter referred to as subordinate CPUs 271, etc.) of the plurality of control ECUs 203, 204, and 205, respectively, for starting up slave ECUs 206-211. The slave startup processing is started, for example, when the power supply to the control ECUs 203, 204, and 205 is turned on.

As shown in FIG. 17, in the slave startup processing, first, in S1110, the subordinate CPUs 271, etc. determine whether an NM frame has been received. The NM frame here may include a configuration notification and a startup command transmitted by the management ECU 202.

Next, in S1115, the subordinate CPUs 271, etc. configure the system to communicate via the new communication path according to the configuration notification. The subordinate CPUs 271, etc. store the new communication path and the previous communication path in the storage units 264, 284, and 304. These new and previous communication paths can be read from the storage units 264, 284, and 304 when the subordinate CPUs 271, etc. are restarted.

Next, in S1120, the subordinate CPUs 271, etc. determine whether to start up the subordinate ECU according to the NM frame. The subordinate ECUs refer to the slave ECUs 206-211 under the control of the control ECUs 203, 204, and 205, respectively. The slave ECUs 206 and 207 are under control ECU 203, slave ECUs 208 and 209 are under control ECU 204, and slave ECUs 210 and 211 are under control ECU 205. Note that, from the perspective of the management ECU 202, the control ECUs 203, 204, and 205 may also be regarded as subordinate ECUs.

In S1120, for example, if there is no need to start up a subordinate ECU, as in the case of control ECU 204 simply relaying the NM frame, a negative determination is made and the process proceeds to S1150. If a subordinate ECU is to be started up, as in the case of control ECU 203 starting up slave ECU 206, a positive determination is made and the process proceeds to S1130.

Next, in S1130, the subordinate CPUs 271, etc. set the power distribution switch corresponding to the subordinate ECU to the on state. As a result, power is supplied to the subordinate ECU and the ECU is started up. For example, when control ECU 203 turns on the power supply to slave ECU 206 (i.e., supplies power), it sets power distribution switch 265 to the on state.

Next, in S1140, the subordinate CPUs 271, etc. determine whether the startup time has elapsed. The startup time is the time from when the power supply to the subordinate ECU is turned on until startup is completed. The startup time is generally the same as the diagnostic mask time. If the startup time has not elapsed, S1140 is repeated. If the startup time has elapsed, the process proceeds to S1150.

Next, in S1150, the subordinate CPUs 271, etc. transmit the NM frame to the next control ECU in the relay or to the subordinate ECU. The NM frame transmitted here may include a configuration notification and a startup command, as in the NM frame received from the management ECU 202. However, when transmitting the NM frame to a subordinate ECU that is already started up, the startup command is unnecessary. When this processing is completed, the present processing ends.

The NM frame may include not only a startup command, but also stop information or a command to wake up or put the ECU to sleep. If the subordinate ECU is in a sleep state, in S1130 described above, the control ECUs 203, 204, and 205 may transmit a wake-up command to the subordinate ECU. If the subordinate ECU is configured to recognize the NM frame even in the sleep state, the control ECUs 203, 204, and 205 may omit transmission of the wake-up command. Alternatively, the subordinate ECU may receive the NM frame transmitted in S1150 and wake itself up.

### Restart Processing

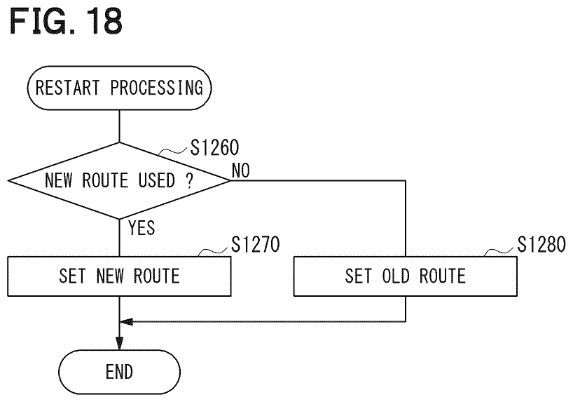

Next, FIG. 18 is a flowchart illustrating the restart processing. The restart processing is started, for example, when, after a change in the communication path, the management ECU 202 enters sleep or power-off state due to ignition off or the like, and then the management ECU 202 is started again. This processing is executed by the CPU 251 of the management ECU 202.

Subsequently, in S1260, the CPU 251 of the management ECU 202 determines whether the system is configured to use the new communication path. Here, when the management ECU 202 is restarted after a communication disconnection has been detected, it is predetermined whether communication will be conducted using the new communication path or the previous communication path that was used before the communication disconnection. This setting can be changed arbitrarily and is shared among all devices constituting the network using NM frames or the like. If the new communication path is to be used, the process proceeds to S1270. If the previous communication path is to be used, the process proceeds to S1280.

Next, in S1270, the CPU 251 of the management ECU 202 sets the system to use the new communication path. In this case, communication is resumed using the new communication path without using the previous communication path.

On the other hand, in S1280, the CPU 251 of the management ECU 202 sets the system to use the previous communication path. In this case, if communication disconnection is detected again during the master startup processing described above, the new communication path will be used. When these processes are completed, the restart processing ends.

Whether the new communication path or the previous communication path is to be used is notified to each device via the configuration notification in the NM frame.

### 4-3. Effects

According to the fourth embodiment described in detail above, the effects of the first embodiment and the third embodiment described previously are achieved, and further, the following effects are obtained.
(4a) In the fourth embodiment, when an abnormality occurs in a communication path, a new communication path that avoids the abnormal part can be established, and communication can be conducted using this new communication path, thereby making it less likely that necessary communication cannot be performed.
(4b) In the fourth embodiment, when the management ECU 202 is restarted, communication using the new communication path can be performed. This is effective in cases where, for example, there is physical damage to the communication path and restarting the management ECU 202 does not improve the situation.
(4c) In the fourth embodiment, the same effects as those of the first and second embodiments are achieved for configurations that are similar.

### 5. Other Embodiments

Although embodiments of the present disclosure have been described above, it is needless to say that the present disclosure is not limited to the above embodiments and may take various forms.
(5a) The operation of the communication system described in the present disclosure may be implemented by a dedicated computer provided by configuring a processor and memory programmed to execute one or more functions embodied in a computer program.

Alternatively, the operation of the communication system described in the present disclosure may be implemented by a dedicated computer provided by configuring a processor with one or more dedicated hardware logic circuits.

Alternatively, the operation of the communication system described in the present disclosure may be implemented by one or more dedicated computers configured by a combination of a processor and memory programmed to execute one or more functions and a processor configured with one or more hardware logic circuits.

Further, the computer program may be stored as instructions to be executed by a computer on a computer-readable non-transitory tangible recording medium. The method for realizing the functions of the communication system does not necessarily have to include software, and all functions may be realized using one or more hardware components.
(5b) In addition to the above-described communication system, the present disclosure may also be realized in various forms, such as a configuration including the communication system as a component, a program for operating the computer of the communication system, a non-transitory tangible recording medium such as a semiconductor memory on which the program is recorded, and a communication method.
(5c) The multiple functions possessed by one component in each of the above embodiments may be realized by a plurality of components, or one function possessed by one component may be realized by a plurality of components. Further, multiple functions possessed by a plurality of components may be realized by one component, or one function realized by a plurality of components may be realized by one component. In addition, part of the configuration of each embodiment may be omitted. Furthermore, at least part of the configuration of each embodiment may be added to or substituted for the configuration of another embodiment.

What is claimed is:

1. A communication system comprising
a first electronic control device; and
a plurality of second electronic control devices,
wherein
the first electronic control device and the plurality of second electronic control devices are each communicably connected via a main path,
at least one of the plurality of second electronic control devices is communicably connected to another of the second electronic control devices via a redundant path having a lower transmission capacity with respect to data communication amount than the main path,
the first electronic control device is configured to transmit data to the second electronic control device, which is a transmission target of the data, via the main path connected to the second electronic control device, which is a transmission target of the data, and
the first electronic control device is configured to transmit the data to the second electronic control device, which is a transmission target of the data, by reducing the data communication amount via a backup path including another main path different from the main path and the redundant path.

2. The communication system according to claim 1, further comprising
a disconnection detection unit configured to detect a communication disconnection of the main path between the first electronic control device and any of the second electronic control devices,
wherein
when the disconnection detection unit detects a communication disconnection of the main path, the data is transmitted via a backup route including a main path other than the disconnected main path and the redundant path.

3. The communication system according to claim 2, wherein
each of the second electronic control devices includes the disconnection detection unit, and
each of the second electronic control devices is configured to perform processing for transmitting the data via the backup path when the disconnection detection unit detects a communication disconnection of the main path.

4. The communication system according to claim 3, wherein
the first electronic control device or each of the second electronic control devices is configured to reduce information amount of the data to be transmitted when transmitting the data via the backup path.

5. The communication system according to claim 3, wherein
when transmitting the data via the backup path, the first electronic control device or each of the second electronic control devices is configured not to transmit the data if the data to be transmitted is not disconnection transmission target data to be transmitted at a time of a communication disconnection.

6. The communication system according to claim 1, wherein
when transmitting the data via the redundant path, each of the second electronic control devices is configured to segment the data and transmit the segmented data in accordance with the data communication amount transmittable via the redundant path.

7. The communication system according to claim 1, wherein
each of the second electronic control devices is configured to transmit the data via the redundant path based on priority information included in the data to be transmitted, the priority information specifying transmission priority.

8. The communication system according to claim 1, wherein
each of the second electronic control devices is configured to transmit the data via the redundant path in accordance with a predetermined transmission priority depending on a situation of a communication disconnection.

9. The communication system according to claim 2, wherein
the first electronic control device includes the disconnection detection unit, and
the first electronic control device is configured to perform processing for transmitting the data via the backup path when the disconnection detection unit detects a communication disconnection of the main path.

10. The communication system according to claim 1, wherein
when communication via the main path between the first electronic control device and the second electronic control device is not disconnected,
the first electronic control device is configured to transmit the data to the second electronic control device, which is the transmission target of the data, via the main path connected to the second electronic control device, which is a transmission target of the data, and
the first electronic control device is further configured to transmit the data to the second electronic control device by reducing the data communication amount via a backup path including another main path different from the main path and the redundant path.

11. The communication system according to claim 1, wherein
a communication frame includes information specifying whether the electronic control device to be controlled is to be set to an on state in which power supply is permitted or to an off state in which power supply is prohibited, and
the communication frame is configured to be transmitted via the main path and the redundant path.
